(19) United States
(12) Patent Application Publication
(10) Pub. No.: US 2015/0096650 A1
(43) Pub. Date: Apr. 9, 2015

(54) Knife assembly of planer head

(71) Applicant: Yu-Kun Chen, Taichung (TW)

(72) Inventor: Yu-Kun Chen, Taichung (TW)

(21) Appl. No.: 14/047,003

(22) Filed: Oct. 6, 2013

(51) Int. Cl. B27G 13/04; B27C 1/00

(52) U.S. Cl. CPC B27G 13/04; B27C 1/00
USPC 144/225

(57) ABSTRACT

A planer head is provided with an axis; a plurality of elongated knife carrier assemblies circumferentially formed on the axis, each of the knife carrier assemblies including a first surface, a second surface butted on both the first surface thereof and the first surface of an adjacent one of the knife carrier assemblies, and a plurality of threaded holes disposed on the first surface; a plurality of knives each having a plurality of through holes; and a plurality of threaded fasteners driven the through holes into the threaded holes to secure the knives to the first surfaces of the knife carrier assemblies. Along the axis, the knives are equally spaced apart.

### BACKGROUND OF THE INVENTION

1. Field of the Invention

The invention relates to power planers and more particularly to a knife assembly of a head of a thickness planer with improved characteristics.

2. Description of Related Art

A thickness planer is a woodworking machine used to create boards that are of an even thickness throughout their length and flat on both surfaces. A typical thickness planer comprises a cutter head containing cutting knives, a set of in feed and out feed rollers for drawing an article of wood through the machine, and a table adjustable relative to the cutter head for controlling the resultant thickness of the article of wood.

There is a typical planer head comprising three circumferentially spaced knife carriers. Each knife carrier is provided with a plurality of spaced knives each threadedly secured to the knife carrier. The planer head is placed on an article of wood for flattening. Almost all portions of the top surface of the article of wood can be worked by the planer head.

However, the knives may be loosened after a period of time of operation due to single screw fastening. Thus, the need for improvement still exists.

### SUMMARY OF THE INVENTION

It is therefore one object of the invention to provide a planer head comprising, in combination an axis; a plurality of elongated knife carrier assemblies circumferentially formed on the axis, each of the knife carrier assemblies including a first surface, a second surface butted on both the first surface thereof and the first surface of an adjacent one of the knife carrier assemblies, and a plurality of threaded holes disposed on the first surface; a plurality of knives each having a plurality of through holes; and a plurality of threaded fasteners driven the through holes into the threaded holes to secure the knives to the first surfaces of the knife carrier assemblies; wherein along the axis, the knives are equally spaced apart so that width of a top of an article of wood being planed after one revolution of the knife carrier assemblies is about equal to length of the knife carrier assemblies.

The above and other objects, features and advantages of the invention will become apparent from the following detailed description taken with the accompanying drawings.

### BRIEF DESCRIPTION OF THE DRAWINGS

FIG. 1 is a perspective view of a knife assembly of a planer head according to the invention;

FIG. 2 is another view of the knife assembly shown in FIG. 1;

FIG. 3 is an exploded view of the knife assembly shown in FIG. 1; and

FIG. 4 is a side elevation in part section of the planer head of FIG. 1 placed and worked on an article of wood for smoothing its surface.

### DETAILED DESCRIPTION OF THE INVENTION

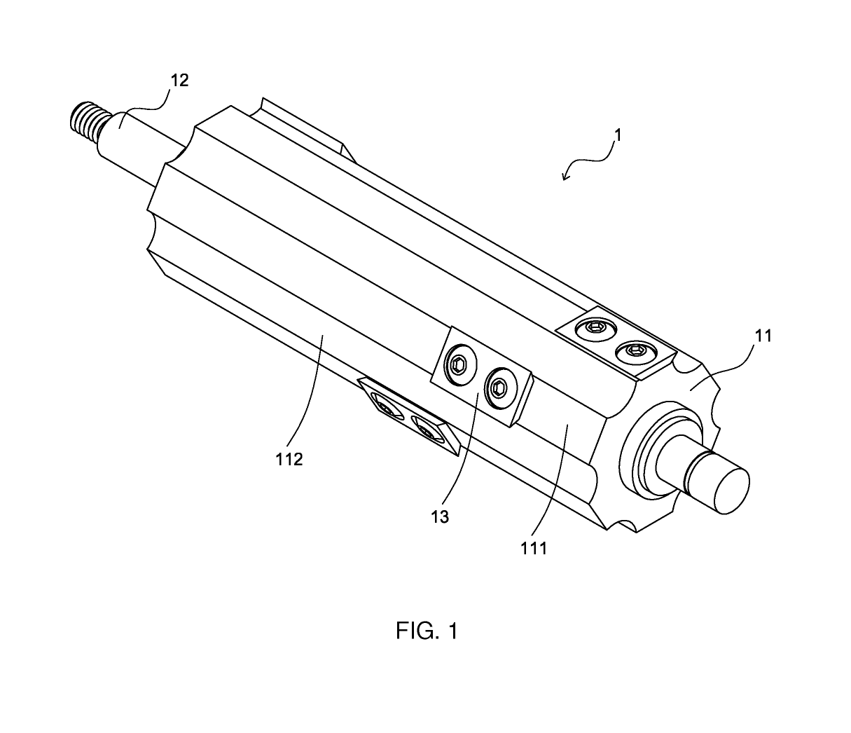

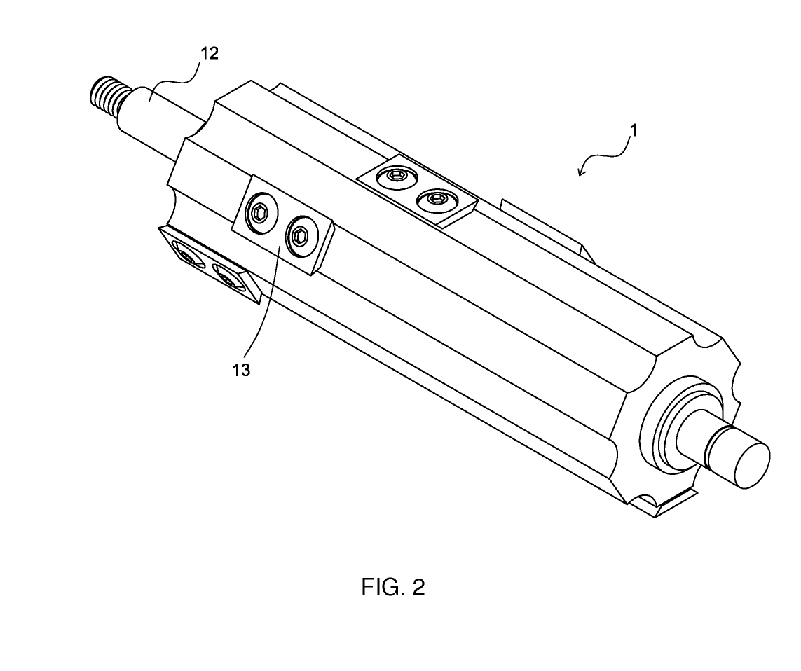

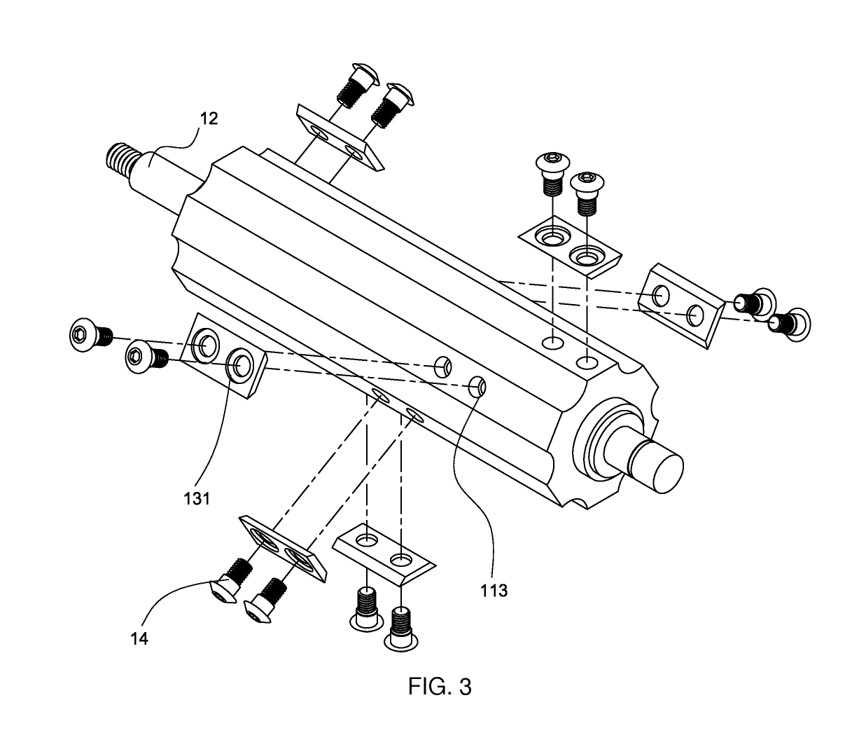

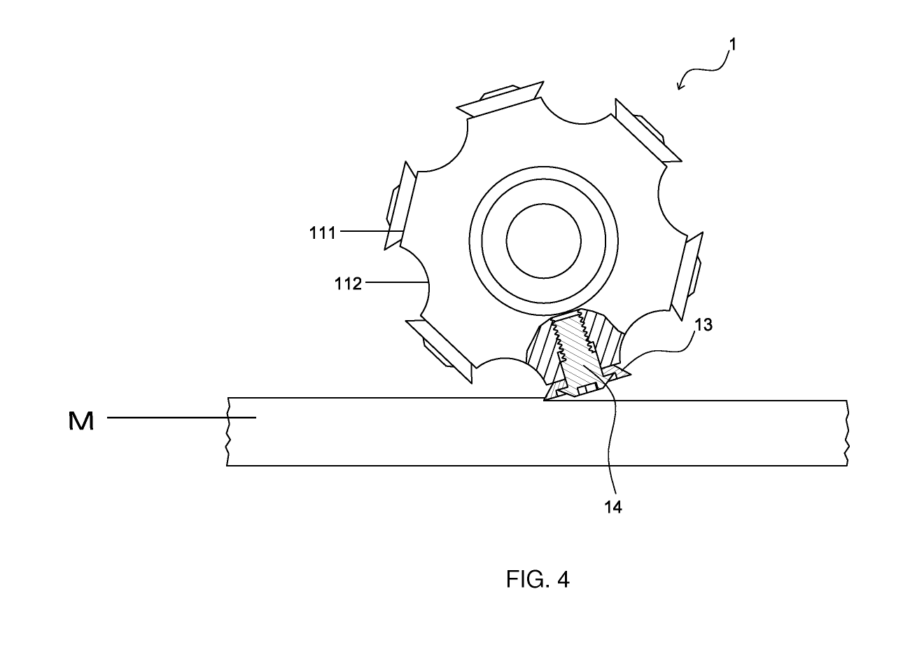

Referring to FIGS. 1 to 4, a planer head 1 in accordance with the invention is cylindrical and comprises the following components as discussed in detail below.

An axis 12 is formed through the planer head 1. Six knife carrier assemblies 11 are circumferentially, equally spaced apart and integrally formed on the axis 12. Each knife carrier assembly 11 comprises a rectangular flat surface 111 and a groove 112 abutted on the rectangular flat surface 111 of an adjacent knife carrier assembly 11. The groove 112 has a curved surface. Six sets of two threaded holes 113 are provided in which each set of the threaded holes 113 are provided on the rectangular flat surface 111 of the knife carrier assembly 11. A plurality of rectangular knives 13 each have two through holes 131. Six sets of two screws 14 are driven through the through holes 131 into the threaded holes 113 to secure the knife 13 to the rectangular flat surface 111 of the knife carrier assembly 11. As a result, the knives 13 are secured to the knife carrier assemblies 11.

Preferably, along the direction of the axis 12, the knives 13 are equally spaced apart. Thus, different portions of an article of wood M can be worked by the knives 13. Further, it is envisaged by the invention that width of the top surface of the article of wood M being worked by the planer head 1 after one revolution is about the same as the length of the planer head 1.

Alternatively, the number of the knife carrier assemblies 11 is eight.

While the invention has been described in terms of preferred embodiments, those skilled in the art will recognize that the invention can be practiced with modifications within the spirit and scope of the appended claims.

What is claimed is:

1. A planer head comprising, in combination;
an axis;
a plurality of elongated knife carrier assemblies circumferentially formed on the axis, each of the knife carrier assemblies including a first surface, a second surface butted on both the first surface thereof and the first surface of an adjacent one of the knife carrier assemblies, and a plurality of threaded holes disposed on the first surface;
a plurality of knives each having a plurality of through holes; and
a plurality of threaded fasteners driven the through holes into the threaded holes to secure the knives to the first surfaces of the knife carrier assemblies;
wherein along the axis, the knives are equally spaced apart so that width of a top of an article of wood being planed after one revolution of the knife carrier assemblies is about equal to length of the knife carrier assemblies.

2. The planer head of claim 1, wherein the knife carrier assemblies are six knife carrier assemblies which are spaced apart.

3. The planer head of claim 1, wherein the knife carrier assemblies are eight knife carrier assemblies which are spaced apart.

4. The planer head of claim 1, wherein the knife carrier assemblies are circumferentially, equally spaced apart.

5. The planer head of claim 1, wherein the first surfaces of the knife carrier assemblies are rectangular flat surfaces.

6. The planer head of claim 1, wherein the second surfaces of the knife carrier assemblies are elongated concave surfaces.
